(19) United States
(12) Patent Application Publication
(10) Pub. No.: US 2011/0117249 A1
(43) Pub. Date: May 19, 2011

(54) BITE SIZED BURRITO SYSTEMS

(76) Inventor: Karla Ward, Las Vegas, NV (US)

(21) Appl. No.: 12/942,895

(22) Filed: Nov. 9, 2010

Related U.S. Application Data
(60) Provisional application No. 61/262,591, filed on Nov. 19, 2009.

(51) Int. Cl. A23L 1/31; A23B 4/06; A23L 1/025

(52) U.S. Cl. 426/92; 426/418; 426/243

(57) ABSTRACT

B'Rito Bites comprise bite-sized freezable tortilla snacks that have a Mexican flavored filling. B'Rito Bites are designed to provide a healthier alternative to snack products currently available on the market and comprise tortillas which are stuffed with various combinations of meat, beans, and/or cheese. Meat may include beef, chicken, pork and other suitable alternatives. Other ingredients may also be added such as spices, different cheeses, salsas, sauces, rice, beans and other. B'Rito Bites may be perfect for after school snacks, hors d'oeuvres, meal replacements, and more.

### CROSS-REFERENCE TO RELATED APPLICATION

The present application is related to and claims priority from prior provisional application Ser. No. 61/262,591, filed Nov. 19, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of burrito comestibles and more specifically relates to bite-sized burritos.

2. Description of the Related Art

Burritos are a traditional type of Mexican food. Typically burritos consist of a flour tortilla wrapped or folded around a filling. The flour tortilla is usually lightly grilled or steamed, to soften it and make it more pliable. In Mexico, refried beans, Mexican rice, or meat are usually the only fillings and the tortilla is smaller in size. In the United States, however, fillings generally include a combination of ingredients such as Mexican rice, beans, lettuce, salsa, meat, avocado, cheese, and sour cream, and the size varies, with some burritos considerably larger than their Mexican counterparts.

Many individuals enjoy partaking in a snack between meals. Children appreciate a snack after a busy day at school. Many people opt for frozen snack foods due to their quick and easy preparation. However, frozen comestibles typically consist of greasy, fried snack products, often high in sodium. Mothers like to feel confident that they are providing their children with healthy meals which may be difficult to prepare, given busy schedules and unhealthy fast-food options. Further, consumers in general are always looking for healthy and delicious food alternatives that are easy to make. When throwing a party, it is advantageous to have tasty hors d'oeuvres ready for serving.

Various attempts have been made to solve the above-mentioned problems such as those found in U.S. Pat. Nos. 4,399,156; 4,491,601; and 4,691,627. This prior art is representative of burrito comestibles and methods of producing such comestibles. None of the above inventions and patents, taken either singly or in combination, is seen to describe the invention as claimed.

Ideally, a burrito comestible should be healthy, easy to prepare, readily storable and be manufactured at a modest expense. Thus, a need exists for a bite-sized burrito system to avoid the above-mentioned problems.

### BRIEF SUMMARY OF THE INVENTION

In view of the foregoing disadvantages inherent in the known fast-food art, the present invention provides a novel bite-sized burrito system. The general purpose of the present invention, which will be described subsequently in greater detail is to provide a healthy snack alternative that is quick and easy to prepare.

The present invention is disclosed herein as Bite-sized burritos comprising: at least one meat filling; at least one cheese filling; taco seasoning, tortilla shells (flour or corn); wherein the tortilla shells when filled with the meat filling, cheese filling, and taco seasoning, comprise a bite-size snack. Meat filling may comprise beef, chicken, and/or pork possibly further comprising onions, and refried beans. The bite-sized burritos may comprise eggs in ‘breakfast versions’.

The bite-sized burritos are freezable for storage and may be deep-fried, oven baked, and/or microwave-preparable.

A method for storing and preparing bite-sized burritos is also disclosed herein comprising the steps of: storing the bite-sized burritos in a frozen state; preparing the bite sized burritos via a heating device; and ingesting the bite-sized burritos.

The present invention holds significant improvements and serves as a bite-sized burrito system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, bite-sized burritos, constructed and operative according to the teachings of the present invention.

FIG. 1 shows a perspective view illustrating bite-sized burritos according to an embodiment of the present invention.

FIG. 2 is a flowchart illustrating a method of storing, preparing and eating bite-sized burritos according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to burrito comestibles and more particularly to bite-sized burritos as used to provide healthy choices for individuals seeking a fast-food alternative that is quick and easy to prepare.

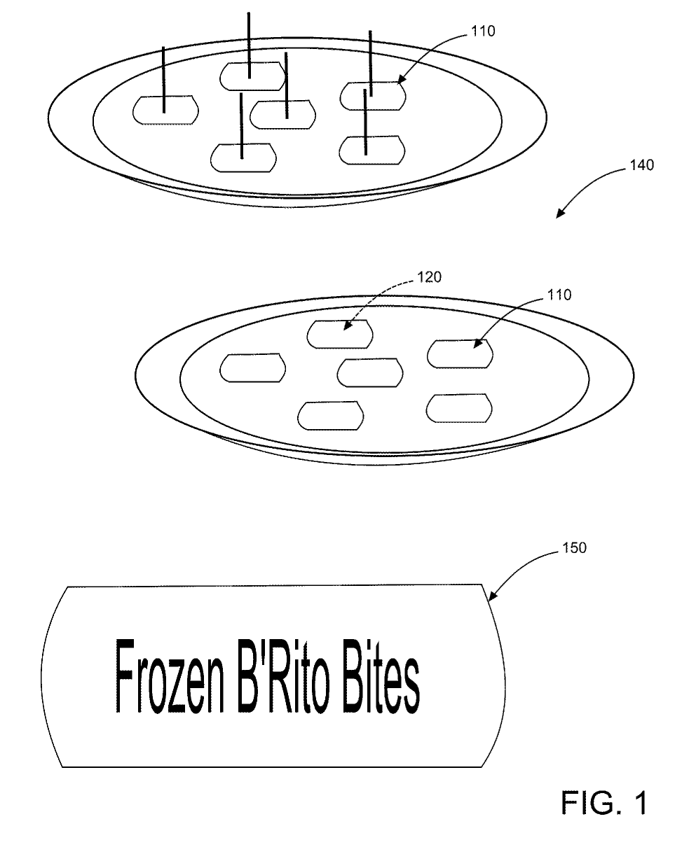

Referring to the drawings by numerals of reference there is shown in FIG. 1, a perspective view illustrating bite-sized burritos (B'Rito Bites 110) according to an embodiment of the present invention.

B'Rito Bites 110 of the present invention comprises tortilla snacks that have a Mexican flavored filling 120. B'Rito Bites 110 are designed to provide a healthier alternative to snack products currently available on the market, as discussed previously. B'Rito Bites 110 comprise tortillas which are preferably stuffed with various combinations of meat, beans, and/or cheese. Meat may comprise beef, chicken, pork and other suitable alternatives. The combinations may be changed to provide an assortment of choices for the consumer. Other ingredients may also be added such as spices, different cheeses, salsas, sauces, rice, beans and other such ingredients. B'Rito Bites 110 may be perfect for after school snacks, hors d'oeuvres (both shown in FIG. 1), meal replacements, and more. B'Rito Bites 110 are small enough for toddlers to grasp with their tiny fingers, as well as ideal for adults.

B'Rito Bites 110 of the present invention provide consumers with a tasty Mexican snack. The product comprises bite-size tortillas (B'Rito Bites 110) made especially for the present snack product. B'Rito Bites 110 as disclosed comprise tortillas which may be preferably filled with ground beef, cheese, taco seasoning, onions, refried beans, and more. The product may be made using different combinations of the ingredients to accommodate user preferences. Additional B'Rito Bites 110 fillings may be provided, such as green chili, barbeque beef, and tortillas filled with breakfast products. Upon reading this specification, it should be appreciated that, under appropriate circumstances, considering such issues as user preferences, design preference, structural requirements, marketing preferences, cost, available materials, technological advances, etc., other ingredients and sizes such as, for example, larger or smaller bite sized pieces, etc., may be sufficient.

B'Rito Bites 110 may be made in the following exemplary manner: tortillas cut into about 2″×3″ rectangular pieces moistened slightly to loosen/soften the gluten; hamburger/chicken/shredded beef/sausage/other ingredients cooked in desired taco or other user-preferred seasoning using the approximate ratio of one pound meat to one tablespoon minced dried onions to 16 oz refried beans, cheese added as per taste, next heated/cooked and inserted into the cut tortillas and wrapped tightly (manually or machine cut and wrapped) and allowed to dry, then B'Rito Bites 110 may be cooked as described herein. It should be appreciated that other ratios and or ingredients may be substituted and still be considered within the scope of the invention.

B'Rito Bites 110 may be sold as kit 140 comprising the following parts: at least one B'Rito Bite 110; at least one package 150 for freezably storing B'Rito Bites 110; at least one dipping salsa; and at least one set of user storing/cooking instructions. B'Rito Bites 110 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents may be sufficient.

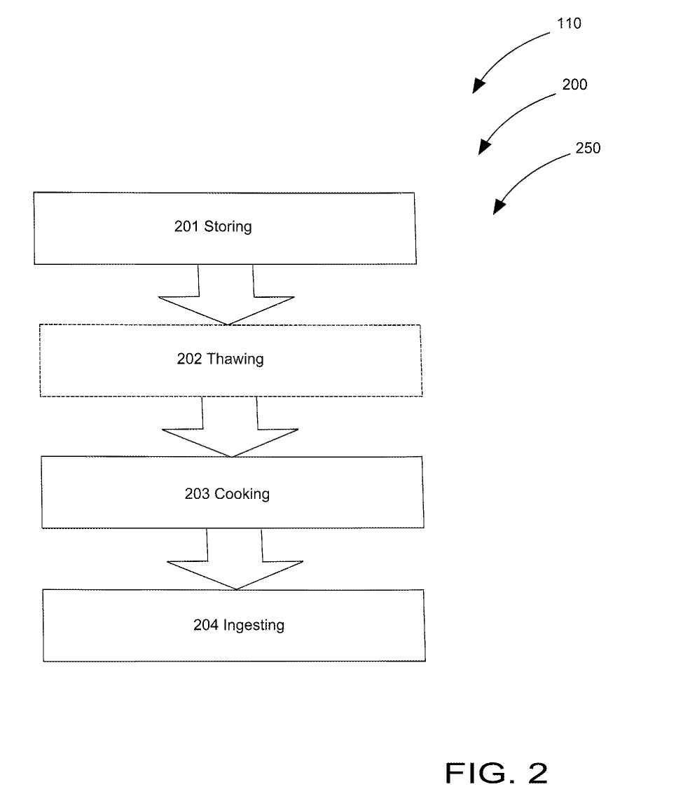

Referring now to FIG. 2 a flowchart 250 illustrating a method of storing and preparing 200 bite-sized burritos (B'Rito Bites 110) according to an embodiment of the present invention of FIG. 1.

B'Rito Bites 110 are designed to be frozen and sold in the freezer aisle and may be stored in a consumer's freezer. B'Rito Bites 110 may be prepared in a microwave, oven, or deep fried if preferred. Those with ordinary skill in the art will now appreciate that upon reading this specification and by their understanding the art burritos as described herein, methods of storing, preparing and ingesting of such comestibles will be understood by those knowledgeable in such art.

Method of storing and preparing 200 B'Rito Bites 110 may comprise the following steps, step one 201 storing B'Rito Bites 110 in a frozen state; optionally step two 202, the consumer may thaw B'Rito Bites 110 before cooking; and step three 203 cooking B'Rito Bites 110; and step four 204 ingesting B'Rito Bites 110. As mentioned previously B'Rito Bites 110 may be cooked using a microwave, an oven or a deep fryer.

It should be noted that step three 202 is an optional step and may not be implemented in all cases. Optional steps of method 200 are illustrated using dotted lines in FIG. 2 so as to distinguish them from the other steps of method 200.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. Bite-sized burritos comprising:
at least one meat filling;
at least one cheese filling;
taco seasoning,
tortilla shells;
wherein said tortilla shells when filled with said at least one meat filling, said cheese filling, and said taco seasoning, comprise a bite-size snack.

2. The bite-sized burritos of claim 1 wherein said meat filling comprises beef.

3. The bite-sized burritos of claim 1 wherein said meat filling comprises chicken.

4. The bite-sized burritos of claim 1 wherein said meat filling comprises pork.

5. The bite-sized burritos of claim 1 further comprising onions, and refried beans.

6. The bite-sized burritos of claim 1 further comprising eggs.

7. The bite-sized burritos of claim 1 wherein said bite-sized burritos are freezable for storage.

8. The bite-sized burritos of claim 1 wherein said bite-sized burritos are deep-fried.

9. The bite-sized burritos of claim 1 wherein said bite-sized burritos are oven-baked.

10. The bite-sized burritos of claim 1 wherein said bite-sized burritos are microwave preparable.

11. A method for storing and preparing bite-sized burritos comprising the steps of:
storing said bite-sized burritos in a frozen state;
preparing said bite-sized burritos via a heating device; and
ingesting said bite-sized burritos.

12. The method for storing and preparing bite-sized burritos of claim 11 wherein said heating device comprises a microwave.

13. The method for storing and preparing bite-sized burritos of claim 11 wherein said heating device comprises a deep fryer.

14. The method for storing and preparing bite-sized burritos of claim 11 wherein said heating device comprises an oven.
